(19) United States
(12) Patent Application Publication
(10) Pub. No.: US 2026/0297426 A1
(43) Pub. Date: Oct. 1, 2026

(54) Soil Additive and Method for Using Same

(71) Applicant: Kyrk Pyros, Pittsburgh, PA (US)

(72) Inventor: Kyrk Pyros, Pittsburgh, PA (US)

(21) Appl. No.: 19/629,353

(22) Filed: Mar. 26, 2026

Related U.S. Application Data
(60) Provisional application No. 63/778,147, filed on Mar. 26, 2025.

(51) Int. Cl. C09K 17/10; C09K 17/06; C09K 17/08

(52) U.S. Cl. CPC C09K 17/10; C09K 17/06; C09K 17/08

(57) ABSTRACT

The present invention relates to a soil additive that can be used to stabilize wet soil, or soil that will at some point become wet, thereby resulting in a more stable wetted soil that is less prone to items sinking into same. In one embodiment, the soil additive of the present invention is formed from a mixture of: (a) one or more lime-based compounds; (b) one or more Portland cements; and (c) one or more Group 2 (current IUPAC notation, or Group 2A—previous IUPAC notation) carbonates, hydroxides, oxides, or mixtures thereof.

### CROSS-REFERENCE TO RELATED APPLICATION

This application claims the benefit of U.S. Provisional Patent Application No. 63/778,147, filed Mar. 26, 2025, the disclosure of which is hereby incorporated by reference in its entirety.

### BACKGROUND OF THE INVENTION

### Field of the Invention

The present invention relates to a soil additive that can be used to stabilize wet soil, or soil that will at some point become wet, thereby resulting in a more stable wetted soil that is less prone to items sinking into same. In one embodiment, the soil additive of the present invention is formed from a mixture of: (a) one or more lime-based compounds; (b) one or more Portland cements; and (c) one or more Group 2 (current IUPAC notation, or Group 2A—previous IUPAC notation) carbonates, hydroxides, oxides, or mixtures thereof. In another embodiment, the soil additive of the present invention is formed from a mixture of: (a) one or more lime-based compounds and optionally one or more silica crystalline quartzes; (b) one or more Portland cements and optionally one or more typical Portland cement trace compounds; and (c) one or more Group 2 (current IUPAC notation, or Group 2A—previous IUPAC notation) carbonates, hydroxides, oxides, or mixtures thereof and optionally one or more silica crystalline quartzes and/or one or more silica-alumina crystalline quartzes.

### Description of the Related Art

Various soil types suffer from adverse conditions when wet, waterlogged, or otherwise destabilized due to the presence of water therein. When such a situation occurs, the ability to traverse such soils with one or more pieces of equipment (equipment weighing less than 1 ton (i.e., 2000 pounds), or even heavy equipment weight in excess of 1 ton, 5 tons, 10 tons, 25 tons, 50 tons, 75 tons, 100 tons, or even 150 tons or more without the equipment sinking into the soil is severely compromised. As such, there is a need in the art for a soil additive compound that can effectively treat wet, wetted, or waterlogged soils in order to render same stable for the passage of one or more types of equipment, or heavy equipment, thereover without sinking in.

### SUMMARY OF THE INVENTION

The present invention relates to a soil additive that can be used to stabilize wet soil, or soil that will at some point become wet, thereby resulting in a more stable wetted soil that is less prone to items sinking into same. In one embodiment, the soil additive of the present invention is formed from a mixture of: (a) one or more lime-based compounds; (b) one or more Portland cements; and (c) one or more Group 2 (current IUPAC notation, or Group 2A—previous IUPAC notation) carbonates, hydroxides, oxides, or mixtures thereof. In another embodiment, the soil additive of the present invention is formed from a mixture of: (a) one or more lime-based compounds and optionally one or more silica crystalline quartzes; (b) one or more Portland cements and optionally one or more typical Portland cement trace compounds; and (c) one or more Group 2 (current IUPAC notation, or Group 2A—previous IUPAC notation) carbonates, hydroxides, oxides, or mixtures thereof and optionally one or more silica crystalline quartzes and/or one or more silica-alumina crystalline quartzes.

In one instance, the present invention relates to a method of treating a soil with a soil additive as shown and described herein. In another instance, the present invention relates to a soil additive. In still another instance, the present invention relates to a method of treating a wet, wetted, or waterlogged soil with a soil additive formed from a mixture of: (a) one or more lime-based compounds; (b) one or more Portland cements; and (c) one or more Group 2 (current IUPAC notation, or Group 2A—previous IUPAC notation) carbonates, hydroxides, oxides, or mixtures thereof, where the ratio of components (a) through (c) are adjusted based on the type of soil to be treated.
Clause 1: A soil additive comprising component (a) one or more lime-based compounds; component (b) one or more Portland cements; and component (c) one or more of calcite, calcium oxide, calcium hydroxide, calcium magnesium carbonate, calcium magnesium oxide, magnesium carbonate, or magnesium oxide, and optionally one or more silica crystalline quartzes and/or one or more silica-alumina crystalline quartzes.
Clause 2: The soil additive of clause 1, wherein the soil additive further comprises one or more silica crystalline quartzes in one or more of component (a) or (c).
Clause 3: The soil additive of clause 1, wherein component (b) is formed from Type I Portland cement, Type IA Portland cement, Type II Portland cement, Type IIA Portland cement, Type II(MH) Portland cement, Type II(MH)A Portland cement, Type III Portland cement, Type IIIA Portland cement, Type IV Portland cement, Type V Portland cement, or mixtures of any two or more thereof.
Clause 4: The soil additive of clause 1, wherein component (b) optionally further comprises one or more of the following minor constituents comprising 0 weight percent to about 7 weight percent calcium oxide (CaO); 0 weight percent to about 0.5 weight percent quartz; about 2 weight percent to about 11 weight percent gypsum; 0 weight percent to about 7 weight percent limestone; and/or 0 weight percent to about 6 weight percent magnesium oxide (MgO).
Clause 5: The soil additive of clause 1, wherein component (b) optionally further comprises one or more of the following minor constituents comprising 0 weight percent to about 5 weight percent calcium oxide (CaO); 0 weight percent to about 0.25 weight percent quartz; about 3 weight percent to about 10 weight percent gypsum; 0 weight percent to about 6 weight percent limestone; and/or 0 weight percent to about 5 weight percent magnesium oxide (MgO).
Clause 6: The soil additive of claim 1, wherein component (b) optionally further comprises one or more of the following minor constituents comprising 0 weight percent to about 5 weight percent calcium oxide (CaO); 0 weight percent to about 0.1 weight percent quartz; about 4 weight percent to about 9 weight percent gypsum; 0 weight percent to about 5 weight percent limestone; and/or 0 weight percent to about 4 weight percent magnesium oxide (MgO).
Clause 7: The soil additive of clause 1, wherein component (a) is selected from a quicklime component (a1), a hydrated lime component (a2), or mixtures thereof.
Clause 8: The soil additive of clause 7, wherein the soil additive is formed from about 45 weight percent to about 55 weight percent hydrated lime component (a2); about 35 weight percent to about 45 weight percent Portland cement component (b); and about 5 weight percent to about 15 weight percent component (c).
Clause 9: The soil additive of clause 7, wherein the soil additive is formed from about 5 weight percent to about 15 weight percent quicklime component (a1); about 35 weight percent to about 45 weight percent hydrated lime component (a2); about 25 weight percent to about 35 weight percent Portland cement component (b); and about 15 weight percent to about 25 weight percent component (c).
Clause 10: The soil additive of clause 7, wherein the soil additive is formed from about 25 weight percent to about 35 weight percent quicklime component (a1); about 15 weight percent to about 25 weight percent hydrated lime component (a2); about 15 weight percent to about 25 weight percent Portland cement component (b); and about 25 weight percent to about 35 weight percent component (c).
Clause 11: The soil additive of clause 7, wherein the soil additive is formed from about 45 weight percent to about 55 weight percent quicklime component (a1); about 15 weight percent to about 25 weight percent Portland cement component (b); and about 25 weight percent to about 35 weight percent component (c).
Clause 12: A method of treating a soil with a soil additive, the method comprising the step of mixing the soil with a soil additive to yield a treated soil, the soil additive comprising component (a) one or more lime-based compounds; component (b) one or more Portland cements; and component (c) one or more of calcite, calcium oxide, calcium hydroxide, calcium magnesium carbonate, calcium magnesium oxide, magnesium carbonate, or magnesium oxide, and optionally one or more silica crystalline quartzes and/or one or more silica-alumina crystalline quartzes.
Clause 13: The method of clause 12, wherein the soil additive further comprises one or more silica crystalline quartzes in one or more of component (a) or (c).
Clause 14: The method of clause 12, wherein component (b) is formed from Type I Portland cement, Type IA Portland cement, Type II Portland cement, Type IIA Portland cement, Type II(MH) Portland cement, Type II(MH)A Portland cement, Type III Portland cement, Type IIIA Portland cement, Type IV Portland cement, Type V Portland cement, or mixtures of any two or more thereof.
Clause 15: The method of clause 12, wherein component (b) optionally further comprises one or more of the following minor constituents comprising 0 weight percent to about 7 weight percent calcium oxide (CaO); 0 weight percent to about 0.5 weight percent quartz; about 2 weight percent to about 11 weight percent gypsum; 0 weight percent to about 7 weight percent limestone; and/or 0 weight percent to about 6 weight percent magnesium oxide (MgO).
Clause 16: The method of clause 12, wherein component (b) optionally further comprises one or more of the following minor constituents comprising 0 weight percent to about 5 weight percent calcium oxide (CaO); 0 weight percent to about 0.25 weight percent quartz; about 3 weight percent to about 10 weight percent gypsum; 0 weight percent to about 6 weight percent limestone; and/or 0 weight percent to about 5 weight percent magnesium oxide (MgO).
Clause 17: The method of clause 12, wherein component (b) optionally further comprises one or more of the following minor constituents comprising 0 weight percent to about 5 weight percent calcium oxide (CaO); 0 weight percent to about 0.1 weight percent quartz; about 4 weight percent to about 9 weight percent gypsum; 0 weight percent to about 5 weight percent limestone; and/or 0 weight percent to about 4 weight percent magnesium oxide (MgO).
Clause 18: The method of clause 12, wherein component (a) is selected from a quicklime component (a1), a hydrated lime component (a2), or mixtures thereof.
Clause 19: The method of clause 18, wherein the soil additive is formed from Composition (1) when the water content of the soil to be treated is less than about 10 weight percent, wherein Composition (1) comprises about 45 weight percent to about 55 weight percent hydrated lime component (a2); about 35 weight percent to about 45 weight percent Portland cement component (b); and about 5 weight percent to about 15 weight percent component (c), or Composition (2) when the water content of the soil to be treated is between about 10 weight percent and about 20 weight percent, wherein Composition (2) comprises about 5 weight percent to about 15 weight percent quicklime component (a1); about 35 weight percent to about 45 weight percent hydrated lime component (a2); about 25 weight percent to about 35 weight percent Portland cement component (b); and about 15 weight percent to about 25 weight percent component (c), or Composition (3) when the water content of the soil to be treated is between about 20 weight percent and about 30 weight percent, wherein Composition (3) comprises about 25 weight percent to about 35 weight percent quicklime component (a1); about 15 weight percent to about 25 weight percent hydrated lime component (a2); about 15 weight percent to about 25 weight percent Portland cement component (b); and about 25 weight percent to about 35 weight percent component (c), or Composition (4) when the water content of the soil to be treated is between about 30 weight percent and about 40 weight percent, wherein Composition (4) comprises about 45 weight percent to about 55 weight percent quicklime component (a1); about 15 weight percent to about 25 weight percent Portland cement component (b); and about 25 weight percent to about 35 weight percent component (c).

### DETAILED DESCRIPTION OF THE INVENTION

As used herein, all numbers expressing dimensions, physical characteristics, processing parameters, quantities of ingredients, reaction conditions, and the like, used in the specification and claims are to be understood as being modified in all instances by the term “about”. Accordingly, unless indicated to the contrary, the numerical values set forth in the following specification and claims may vary depending upon the desired properties sought to be obtained by the present invention. At the very least, and not as an attempt to limit the application of the doctrine of equivalents to the scope of the claims, each numerical value should at least be construed in light of the number of reported significant digits and by applying ordinary rounding techniques. Moreover, all ranges disclosed herein are to be understood to encompass the beginning and ending range values and any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more and ending with a maximum value of 10 or less, e.g., 1 to 3.3, 4.7 to 7.5, 5.5 to 10, and the like. “A” or “an” refers to one or more.

As noted above, the present invention relates to a soil additive. In one embodiment, the soil additive of the present invention is formed from a mixture of: (a) one or more lime-based compounds; (b) one or more Portland cements; and (c) one or more Group 2 (current IUPAC notation, or Group 2A—previous IUPAC notation) carbonates, hydroxides, oxides, or mixtures thereof. In another embodiment, the soil additive of the present invention is formed from a mixture of: (a) one or more lime-based compounds and optionally one or more silica-crystalline quartzes; (b) one or more Portland cements and optionally one or more typical Portland cement trace compounds; and (c) one or more Group 2 (current IUPAC notation, or Group 2A—previous IUPAC notation) carbonates, hydroxides, oxides, or mixtures thereof and optionally one or more silica crystalline quartzes and/or one or more silica-alumina crystalline quartzes.

In another embodiment, the present invention relates to a method of treating a soil with a soil additive as shown and described herein. In still another embodiment, the present invention relates to a soil additive. In still another embodiment, the present invention relates to a method of treating a wet, wetted, or waterlogged soil with a soil additive formed from a mixture of: (a) one or more lime-based compounds; (b) one or more Portland cements; and (c) one or more Group 2 (current IUPAC notation, or Group 2A—previous IUPAC notation) carbonates, hydroxides, oxides, or mixtures thereof, where the ratio of components (a) through (c) are adjusted based on the type of soil to be treated.

It should be noted that for the purposes of the present invention the soil additive can be used in conjunction with any type of wet, wetted, or waterlogged soil. In another embodiment, the soil additive of the present invention can be used in conjunction with any type of soil at various ratios depending upon which soil type is present and/or depending upon how much water is present in a given soil type. As such, while not being bound to just those soil types listed below as soil classification types vary, the additive of the present invention can be used in conjunction with (i) sandy soils, (ii) clay soils, (iii) silt soils, (iv) peat soils, (v) chalk soils, (vi) loam soils, and (vii) saline soils.

Turning to sandy soils, this type of soil is light in weight and warm and dry in feel. It is generally formed from small particles of weathered rocks. Sandy soil consists of the largest particles among the different soil types, formed from broken-down fragments of granite, limestone, and quartz. While water quickly drains through the large particles of sandy soil which makes it the perfect soil type for the drainage system, water can destabilize sandy soils when heavy objects pass thereover.

With regard to clay soils, clay soil is the densest and heaviest soil type which contains higher amounts of nutrients and an excellent water-holding capacity. Clay soil has the smallest, tightly packed particles with very little space for air or moisture. While this strengthens the water-holding capabilities of the clay soil, clay soil is still subject to destabilization when wet, wetted, or waterlogged when heavy objects pass thereover.

Turning to silt soils, silt soil has medium-sized particles which are smaller than that of sandy soil but larger than that of clay soil. Silt soil is easily washed away during rain and is transported from one place to another with the moving currents. It is the soil type you would find near water bodies such as rivers and lakes. As with other soil types, silt soil is still subject to destabilization when wet, wetted, or waterlogged when heavy objects pass thereover.

Regarding peat soil, this soil type is known to be the surface layer of soil that contains an exceeding amount of organic matter. Peat soil is composed mainly of decomposed plants that have accumulated for long periods of time. Peat soil has high humus content and greater water retention capability. As with other soil types, peat soil is still subject to destabilization when wet, wetted, or waterlogged when heavy objects pass thereover. 1

Regarding chalk soil, this soil type is formed from chalk or limestone and is alkaline (pH of 7.1 or higher) to a large extent due to calcite being present in it. Where chalky soil is found with good depth, it can retain moisture well and is not likely to dry out quickly in summer. However, as with other soil types, chalk soil is still subject to destabilization when wet, wetted, or waterlogged when heavy objects pass thereover.

Regarding loam soil, this soil type is a blend of sand, silt, and clay and has all the perks of the three soil types. It retains moisture and nutrients exceptionally well and offers a good drainage system which makes it best suited for crop cultivation. This soil is often called agricultural soil for this reason. However, as with other soil types, loam soil is still subject to destabilization when wet, wetted, or waterlogged when heavy objects pass thereover.

Finally, with regard to saline soils, saline soil is the type of soil with soluble salts in high amounts. This type of soil has the presence of sodium, calcium, and magnesium. Again, as with other soil types, saline soil is still subject to destabilization when wet, wetted, or waterlogged when heavy objects pass thereover.

Given the above, any suitable ratio of the soil additive of the present invention to soil can be used in connection with any one or more soil types with further adjustments to the ratio of soil additive to soil being predicated on the amount of water present and/or expected in a job site's soil over a given period of time.

As to the various components of the present invention, the one or more lime-based compounds can be selected from any of or more types of lime compounds including, but not limited to, one or more of calcium hydroxide, hydrated lime, agricultural lime, calcium oxide, chalk, pebble lime, quicklime, sweet lime, dolomite, dolomitic lime, lime putties, limestone, and/or limewash, or mixtures of any two or more thereof. As to the one or more Portland cements, such Portland cement compounds can be selected from any one or more types of Portland cement including, but not limited to, Type I (general purpose Portland cement), Type IA (same as Type I, but when air entrainment is desired), Type II (for moderate sulfate resistance), Type IIA (same as Type II, but when air entrainment is desired), Type II(MH) (much like Type II, but when moderate heat of hydration is desired), Type II(MH)A (same as Type II(MH), but when air entrainment is desired), Type III (for high early strength), Type IIIA (same as Type III, but when air entrainment is desired), Type IV (for low heat of hydration), Type V (for high sulfate resistance), or mixtures of any two or more thereof. As to the calcite, or calcite (CaCO₃), such calcite can be anhydrous or hydrated, or a mixture of both anhydrous and hydrated calcites. Alternatively, the calcite portion of the present invention can be replaced with a one or more Group 2 (current IUPAC notation, or Group 2A—previous IUPAC notation) carbonates, hydroxides, oxides, or mixtures thereof.

Additionally, in another embodiment the present invention relates to a method of treating a soil with a soil additive as shown and described herein. In another instance, the present invention relates to a method of treating a wet, wetted, or waterlogged soil with a soil additive formed from a mixture of one or more lime-based compounds, one or more Portland cements, and calcite (CaCO₃). Again, the calcite portion of the present invention can be replaced with a one or more Group 2 (current IUPAC notation, or Group 2A—previous IUPAC notation) carbonates, hydroxides, oxides, or mixtures thereof.

In still another embodiment, the present invention relates to a method of treating a wet, wetted, or waterlogged soil with a soil additive formed from a mixture of: component (a), where component (a) is formed from one or more lime-based compounds; component (b), where component (b) is formed from one or more Portland cements; and component (c), where component (c) contains calcite (CaCO₃), where the ratio of components (a) through (c) are adjusted based on the type of soil to be treated. Again, the calcite portion of the present invention can be replaced with a one or more Group 2 (current IUPAC notation, or Group 2A—previous IUPAC notation) carbonates, hydroxides, oxides, or mixtures thereof.

Given the above, the present invention will now be described in more detail as it relates to each of component (a), component (b), and component (c).

### Component (a)—Lime-Based Component

As noted above, component (a) of the present soil additive is formed from one or more lime-based compounds including, but not limited to, one or more types of calcium oxide, one or more types of magnesium oxide, and optionally one or more crystalline silicas (which is primarily formed from SiO₂ and can also be referred to as silica crystalline quartz), which for the purposes of this invention is referred to as “quicklime”. In another embodiment, component (a) of the present soil additive is formed from one or more lime-based compounds including, but not limited to, one or more types of calcium hydroxide and optionally one or more crystalline silicas, which for the purposes of this invention is referred to as “hydrated lime”. In still another embodiment, component (a) of the present invention can be any suitable mixture of one or more quicklime, as defined herein, with one or more hydrated lime, as defined herein.

In one embodiment, component (a) is a combination of calcium oxide (CaO), magnesium oxide (MgO), and, optionally, crystalline silica (also referred to as silica crystalline quartz). In this embodiment, component (a) can also be referred to as “quicklime”.

In one embodiment, component (a) is a quicklime comprised of at least about 80 weight percent calcium oxide (CaO), less than about 8 weight percent magnesium oxide (MgO), and, optionally, less than about 4 weight percent crystalline silica (also referred to as silica crystalline quartz), with the remainder of quicklime component (a) being one or more inert fillers, where such one or more inert fillers are selected from any one or more suitable materials including, but not limited to, silica sand, diatomaceous earth (DE), graphite, talc, mica, or combinations of two or more thereof. Here, as well as elsewhere in this specification, it should be noted that although the total amount of each portion of quicklime component (a) may individually total less than 100 weight percent when each portion thereof is taken individually and totaled using less than the broadest amounts disclosed herein, one of skill in the art will realize that this is not the case. Rather, each individual portion of quicklime component (a) of the present invention can be varied within any stated range as desired in order to achieve a total weight percent of 100.

In another embodiment, when component (a) is a quicklime according to the above embodiment, quicklime component (a) is comprised of from about 80 weight percent to about 98 weight percent calcium oxide (CaO), from about 0.5 weight percent to about 8 weight magnesium oxide (MgO), and, optionally, from about 0.1 weight percent to about 4 weight percent crystalline silica (also referred to as silica crystalline quartz), with the remainder of component (a) being inert filler, where such inert filler is selected from any one or more suitable materials including, but not limited to, silica sand, diatomaceous earth (DE), graphite, talc, mica, or combinations of two or more thereof.

In still another embodiment, when component (a) is a quicklime according to the above embodiment, quicklime component (a) is comprised of from about 81 weight percent to about 97 weight percent, or from about 82 weight percent to about 96 weight percent, or from about 83 weight percent to about 95 weight percent, or from about 84 weight percent to about 94 weight percent, or from about 85 weight percent to about 93 weight percent, or from about 86 weight percent to about 92 weight percent, or from about 87 weight percent to about 91 weight percent, or from about 88 weight percent to about 90 weight percent, or even about 89 weight percent calcium oxide (CaO). Here, as well as elsewhere in the specification and claims, individual numerical range limit values from any one or more different embodiments and/or ranges can be combined to form additional non-disclosed and/or new ranges, or even new embodiments.

In still another embodiment, when component (a) is a quicklime according to the above embodiment, quicklime component (a) is comprised of from about 0.75 weight percent to about 7.5 weight percent, or from about 1 weight percent to about 7 weight percent, or from about 1.5 weight percent to about 6.5 weight percent, or from about 2 weight percent to about 6 weight percent, or from about 2.5 weight percent to about 5.5 weight percent, or from about 3 weight percent to about 5 weight percent, or from about 3.5 weight percent to about 4.5 weight percent, or even about 4 weight percent magnesium oxide (MgO). Here, as well as elsewhere in the specification and claims, individual numerical range limit values from any one or more different embodiments and/or ranges can be combined to form additional non-disclosed and/or new ranges, or even new embodiments.

In still another embodiment, when component (a) is a quicklime according to the above embodiment, quicklime component (a) is comprised of from about 0.25 weight percent to about 4 weight percent, or from about 0.5 weight percent to about 3.5 weight percent, or from about 1 weight percent to about 3 weight percent, or from about 1.5 weight percent to about 2.5 weight percent, or even about 2 weight percent crystalline silica (also referred to as silica crystalline quartz). Here, as well as elsewhere in the specification and claims, individual numerical range limit values from any one or more different embodiments and/or ranges can be combined to form additional non-disclosed and/or new ranges, or even new embodiments.

In another embodiment, component (a) is a hydrated lime comprised of at least about 80 weight percent calcium hydroxide (Ca(OH)₂) and optionally up to about 2 weight percent of one or more crystalline silicas. In still another embodiment, when component (a) is a hydrated lime according to this alternative embodiment, hydrated lime component (a) is comprised of at least about 85 weight percent calcium hydroxide (Ca(OH)₂) and optionally up to about 1.5 weight percent of one or more crystalline silicas. In still another embodiment, when component (a) is a hydrated lime according to this alternative embodiment, hydrated lime component (a) is comprised of at least about 90 weight percent calcium hydroxide (Ca(OH)₂) and optionally up to about 1 weight percent of one or more crystalline silicas. In these embodiments, the remaining material in the hydrated lime component (a) can be one or more inert fillers, where such one or more inert fillers are selected from any one or more suitable materials including, but not limited to, silica sand, diatomaceous earth (DE), graphite, talc, mica, or combinations of two or more thereof. Here, as well as elsewhere in this specification, it should be noted that although the total amount of each portion of hydrated lime component (a) may individually total less than 100 weight percent when each portion thereof is taken individually and totaled using less than the broadest amounts disclosed herein, one of skill in the art will realize that this is not the case. Rather, each individual portion of hydrated lime component (a) of the present invention can be varied within any stated range as desired in order to achieve a total weight percent of 100.

In still another embodiment, when component (a) is a hydrated lime according to the above embodiment, hydrated lime component (a) is comprised of from about 81 weight percent to about 99 weight percent, or from about 82 weight percent to about 98 weight percent, or from about 83 weight percent to about 97 weight percent, or from about 84 weight percent to about 96 weight percent, or from about 85 weight percent to about 95 weight percent, or from about 86 weight percent to about 94 weight percent, or from about 87 weight percent to about 93 weight percent, or from about 88 weight percent to about 92 weight percent, or from about 89 weight percent to about 91 weight percent, or even about 90 weight percent calcium hydroxide (Ca(OH)₂). Here, as well as elsewhere in the specification and claims, individual numerical range limit values from any one or more different embodiments and/or ranges can be combined to form additional non-disclosed and/or new ranges, or even new embodiments.

In still another embodiment, when component (a) is a hydrated lime according to the above embodiment, hydrated lime component (a) is comprised of from 0 weight percent to about 2 weight percent, or from about 0.1 weight percent to about 1.75 weight percent, or from about 0.25 weight percent to about 1.5 weight percent, or from about 0.5 weight percent to about 1.25 weight percent, or even about 1 weight percent crystalline silica (also referred to as silica crystalline quartz). Here, as well as elsewhere in the specification and claims, individual numerical range limit values from any one or more different embodiments and/or ranges can be combined to form additional non-disclosed and/or new ranges, or even new embodiments.

In yet another embodiment, component (a) can be a combination of both quicklime component (a) and hydrated lime component (a). In this embodiment, component (a) is then formed from of quicklime component (a1) and hydrated lime component (a2). In one embodiment, the amount of quicklime component (a1) to hydrated lime component (a2) is in the range of 0 weight percent to 100 weight percent quicklime component (a1) to 100 weight percent to 0 weight percent hydrated lime component (a2) based on the overall amount of component (a) present. In another embodiment, the amount of quicklime component (a1) to hydrated lime component (a2) is in the range of 2.5 weight percent to 97.5 weight percent quicklime component (a1) to 97.5 weight percent to 2.5 weight percent hydrated lime component (a2) based on the overall amount of component (a) present, or from 5 weight percent to 95 weight percent quicklime component (a1) to 95 weight percent to 5 weight percent hydrated lime component (a2) based on the overall amount of component (a) present, or from 7.5 weight percent to 92.5 weight percent quicklime component (a1) to 92.5 weight percent to 7.5 weight percent hydrated lime component (a2) based on the overall amount of component (a) present, or from 10 weight percent to 90 weight percent quicklime component (a1) to 90 weight percent to 10 weight percent hydrated lime component (a2) based on the overall amount of component (a) present, or from 12.5 weight percent to 87.5 weight percent quicklime component (a1) to 87.5 weight percent to 12.5 weight percent hydrated lime component (a2) based on the overall amount of component (a) present, or from 15 weight percent to 85 weight percent quicklime component (a1) to 85 weight percent to 15 weight percent hydrated lime component (a2) based on the overall amount of component (a) present, or from 17.5 weight percent to 82.5 weight percent quicklime component (a1) to 82.5 weight percent to 17.5 weight percent hydrated lime component (a2) based on the overall amount of component (a) present, or from 20 weight percent to 80 weight percent quicklime component (a1) to 80 weight percent to 20 weight percent hydrated lime component (a2) based on the overall amount of component (a) present, or from 22.5 weight percent to 77.5 weight percent quicklime component (a1) to 77.5 weight percent to 22.5 weight percent hydrated lime component (a2) based on the overall amount of component (a) present, or from 25 weight percent to 75 weight percent quicklime component (a1) to 75 weight percent to 25 weight percent hydrated lime component (a2) based on the overall amount of component (a) present, or from 27.5 weight percent to 72.5 weight percent quicklime component (a 1) to 72.5 weight percent to 27.5 weight percent hydrated lime component (a2) based on the overall amount of component (a) present, or from 30 weight percent to 70 weight percent quicklime component (a1) to 70 weight percent to 30 weight percent hydrated lime component (a2) based on the overall amount of component (a) present, or from 32.5 weight percent to 67.5 weight percent quicklime component (a1) to 67.5 weight percent to 32.5 weight percent hydrated lime component (a2) based on the overall amount of component (a) present, or from 35 weight percent to 65 weight percent quicklime component (a1) to 65 weight percent to 35 weight percent hydrated lime component (a2) based on the overall amount of component (a) present, or from 37.5 weight percent to 62.5 weight percent quicklime component (a1) to 62.5 weight percent to 37.5 weight percent hydrated lime component (a2) based on the overall amount of component (a) present, or from 40 weight percent to 60 weight percent quicklime component (a1) to 60 weight percent to 40 weight percent hydrated lime component (a2) based on the overall amount of component (a) present, or from 42.5 weight percent to 57.5 weight percent quicklime component (a 1) to 57.5 weight percent to 42.5 weight percent hydrated lime component (a2) based on the overall amount of component (a) present, or from 45 weight percent to 55 weight percent quicklime component (a1) to 55 weight percent to 45 weight percent hydrated lime component (a2) based on the overall amount of component (a) present, or from 50 weight percent quicklime component (a1) to 50 weight percent hydrated lime component (a2) based on the overall amount of component (a) present. Here, as well as elsewhere in the specification and claims, individual numerical range limit values from any one or more different embodiments and/or ranges can be combined to form additional non-disclosed and/or new ranges, or even new embodiments.

In still another embodiment, the amount of quicklime component (a1) to hydrated lime component (a2) is in the range of 97.5 weight percent to 2.5 weight percent quicklime component (a1) to 2.5 weight percent to 97.5 weight percent hydrated lime component (a2) based on the overall amount of component (a) present, or from 95 weight percent to 5 weight percent quicklime component (a1) to 5 weight percent to 95 weight percent hydrated lime component (a2) based on the overall amount of component (a) present, or from 92.5 weight percent to 7.5 weight percent quicklime component (a1) to 7.5 weight percent to 92.5 weight percent hydrated lime component (a2) based on the overall amount of component (a) present, or from 90 weight percent to 10 weight percent quicklime component (a1) to 10 weight percent to 90 weight percent hydrated lime component (a2) based on the overall amount of component (a) present, or from 87.5 weight percent to 12.5 weight percent quicklime component (a1) to 12.5 weight percent to 87.5 weight percent hydrated lime component (a2) based on the overall amount of component (a) present, or from 85 weight percent to 15 weight percent quicklime component (a1) to 15 weight percent to 85 weight percent hydrated lime component (a2) based on the overall amount of component (a) present, or from 82.5 weight percent to 17.5 weight percent quicklime component (a1) to 17.5 weight percent to 82.5 weight percent hydrated lime component (a2) based on the overall amount of component (a) present, or from 80 weight percent to 20 weight percent quicklime component (a1) to 20 weight percent to 80 weight percent hydrated lime component (a2) based on the overall amount of component (a) present, or from 77.5 weight percent to 22.5 weight percent quicklime component (a1) to 22.5 weight percent to 77.5 weight percent hydrated lime component (a2) based on the overall amount of component (a) present, or from 75 weight percent to 25 weight percent quicklime component (a1) to 25 weight percent to 75 weight percent hydrated lime component (a2) based on the overall amount of component (a) present, or from 72.5 weight percent to 27.5 weight percent quicklime component (a1) to 27.5 weight percent to 72.5 weight percent hydrated lime component (a2) based on the overall amount of component (a) present, or from 70 weight percent to 30 weight percent quicklime component (a1) to 30 weight percent to 70 weight percent hydrated lime component (a2) based on the overall amount of component (a) present, or from 67.5 weight percent to 32.5 weight percent quicklime component (a1) to 32.5 weight percent to 67.5 weight percent hydrated lime component (a2) based on the overall amount of component (a) present, or from 65 weight percent to 35 weight percent quicklime component (a1) to 35 weight percent to 65 weight percent hydrated lime component (a2) based on the overall amount of component (a) present, or from 62.5 weight percent to 37.5 weight percent quicklime component (a 1) to 37.5 weight percent to 62.5 weight percent hydrated lime component (a2) based on the overall amount of component (a) present, or from 60 weight percent to 40 weight percent quicklime component (a1) to 40 weight percent to 60 weight percent hydrated lime component (a2) based on the overall amount of component (a) present, or from 57.5 weight percent to 42.5 weight percent quicklime component (a1) to 42.5 weight percent to 57.5 weight percent hydrated lime component (a2) based on the overall amount of component (a) present, or from 55 weight percent to 45 weight percent quicklime component (a1) to 45 weight percent to 55 weight percent hydrated lime component (a2) based on the overall amount of component (a) present, or from 50 weight percent quicklime component (a1) to 50 weight percent hydrated lime component (a2) based on the overall amount of component (a) present. Here, as well as elsewhere in the specification and claims, individual numerical range limit values from any one or more different embodiments and/or ranges can be combined to form additional non-disclosed and/or new ranges, or even new embodiments.

### Component (b)—Portland Cement Component

Initially, as is known in the art, Portland cement is a hydraulic, powdery binding agent used for a variety of purposes that is produced by heating limestone and clay, then grinding the clinker with gypsum. In some instances, Portland cement offers high compressive strength and durability and, in some instances, when mixed with water and aggregates (sand/gravel) can be used for various applications in the construction arts.

As noted above, the Portland cement that can be used in conjunction with the present invention can be selected from any one or more types of Portland cement including, but not limited to, Type I (general purpose Portland cement), Type IA (same as Type I, but when air entrainment is desired), Type II (for moderate sulfate resistance), Type IIA (same as Type II, but when air entrainment is desired), Type II(MH) (much like Type II, but when moderate heat of hydration is desired), Type II(MH)A (same as Type II(MH), but when air entrainment is desired), Type III (for high early strength), Type IIIA (same as Type III, but when air entrainment is desired), Type IV (for low heat of hydration), Type V (for high sulfate resistance), or mixtures of any two or more thereof.

In one embodiment, the Portland cement component (b) of the present soil additive is composed primarily of Portland cement with optionally one or more of the following minor constituents: 0 weight percent to about 7 weight percent calcium oxide (CaO), 0 weight percent to about 0.5 weight percent quartz (quartz powder or sand), about 2 weight percent to about 11 weight percent gypsum, 0 weight percent to about 7 weight percent limestone, and/or 0 weight percent to about 6 weight percent magnesium oxide (MgO), with the remaining weight percentage of component (b) being formed from at least one type of Portland cement. In another embodiment, the Portland cement component (b) of the present invention is composed primarily of Portland cement with optionally one or more of the following minor constituents: 0 weight percent to about 5 weight percent calcium oxide (CaO), 0 weight percent to about 0.25 weight percent quartz (quartz powder or sand), about 3 weight percent to about 10 weight percent gypsum, 0 weight percent to about 6 weight percent limestone, and/or 0 weight percent to about 5 weight percent magnesium oxide (MgO), with the remaining weight percentage of component (b) being formed from at least one type of Portland cement. In still another embodiment, the Portland cement component (b) of the present invention is composed primarily of Portland cement with optionally one or more of the following minor constituents: 0 weight percent to about 5 weight percent calcium oxide (CaO), 0 weight percent to about 0.1 weight percent quartz (quartz powder or sand), about 4 weight percent to about 9 weight percent gypsum, 0 weight percent to about 5 weight percent limestone, and/or 0 weight percent to about 4 weight percent magnesium oxide (MgO), with the remaining weight percentage of component (b) being formed from at least one type of Portland cement. Here, as well as elsewhere in the specification and claims, individual numerical range limit values from any one or more different embodiments and/or ranges can be combined to form additional non-disclosed and/or new ranges, or even new embodiments.

Here, as well as elsewhere in this specification, it should be noted that although the total amount of each portion of Portland cement component (b) may individually total less than 100 weight percent when each portion thereof is taken individually and totaled using less than the broadest amounts disclosed herein, one of skill in the art will realize that this is not the case. Rather, each individual portion of Portland cement component (b) of the present invention can be varied within any stated range as desired in order to achieve a total weight percent of 100.

In one embodiment, the Portland cement component (b) of the present invention is composed primarily of Portland cement with optionally from 0 weight percent to about 7 weight percent calcium oxide (CaO), from about 0.25 weight percent to about 6.75 weight percent calcium oxide (CaO), from about 0.5 weight percent to about 6.5 weight percent calcium oxide (CaO), from about 0.75 weight percent to about 6.25 weight percent calcium oxide (CaO), from about 1 weight percent to about 6 weight percent calcium oxide (CaO), from about 1.25 weight percent to about 5.75 weight percent calcium oxide (CaO), from about 1.5 weight percent to about 5.5 weight percent calcium oxide (CaO), from about 1.75 weight percent to about 5.25 weight percent calcium oxide (CaO), from about 2 weight percent to about 5 weight percent calcium oxide (CaO), from about 2.25 weight percent to about 4.75 weight percent calcium oxide (CaO), from about 2.5 weight percent to about 4.5 weight percent calcium oxide (CaO), from about 2.75 weight percent to about 4.25 weight percent calcium oxide (CaO), from about 3 weight percent to about 4 weight percent calcium oxide (CaO), from about 3.25 weight percent to about 3.75 weight percent calcium oxide (CaO), or even about 3.5 weight percent calcium oxide (CaO). Here, as well as elsewhere in the specification and claims, individual numerical range limit values from any one or more different embodiments and/or ranges can be combined to form additional non-disclosed and/or new ranges, or even new embodiments.

In one embodiment, the Portland cement component (b) of the present invention is composed primarily of Portland cement with optionally from 0 weight percent to about 0.5 weight percent quartz (quartz powder or sand), or from about 0.025 weight percent to about 0.475 weight percent quartz (quartz powder or sand), or from about 0.05 weight percent to about 0.45 weight percent quartz (quartz powder or sand), or from about 0.075 weight percent to about 0.425 weight percent quartz (quartz powder or sand), or from about 0.1 weight percent to about 0.4 weight percent quartz (quartz powder or sand), or from about 0.125 weight percent to about 0.375 weight percent quartz (quartz powder or sand), or from about 0.15 weight percent to about 0.35 weight percent quartz (quartz powder or sand), or from about 0.175 weight percent to about 0.325 weight percent quartz (quartz powder or sand), or from about 0.2 weight percent to about 0.3 weight percent quartz (quartz powder or sand), or from about 0.225 weight percent to about 0.275 weight percent quartz (quartz powder or sand), or even about 0.25 weight percent quartz (quartz powder or sand). Here, as well as elsewhere in the specification and claims, individual numerical range limit values from any one or more different embodiments and/or ranges can be combined to form additional non-disclosed and/or new ranges, or even new embodiments.

In one embodiment, the Portland cement component (b) of the present invention is composed primarily of Portland cement with optionally from about 2 weight percent to about 11 weight percent gypsum, or from about 2.25 weight percent to about 10.75 weight percent gypsum, or from about 2.5 weight percent to about 10.5 weight percent gypsum, or from about 2.75 weight percent to about 10.25 weight percent gypsum, or from about 3 weight percent to about 10 weight percent gypsum, or from about 3.25 weight percent to about 9.75 weight percent gypsum, or from about 3.5 weight percent to about 9.5 weight percent gypsum, or from about 3.75 weight percent to about 9.25 weight percent gypsum, or from about 4 weight percent to about 9 weight percent gypsum, or from about 4.25 weight percent to about 8.75 weight percent gypsum, or from about 4.5 weight percent to about 8.5 weight percent gypsum, or from about 4.75 weight percent to about 8.25 weight percent gypsum, or from about 5 weight percent to about 8 weight percent gypsum, or from about 5.25 weight percent to about 7.75 weight percent gypsum, or from about 5.5 weight percent to about 7.5 weight percent gypsum, or from about 5.75 weight percent to about 7.25 weight percent gypsum, or from about 6 weight percent to about 7 weight percent gypsum, or from about 6.25 weight percent to about 6.75 weight percent gypsum, or even about 6.5 weight percent gypsum. Here, as well as elsewhere in the specification and claims, individual numerical range limit values from any one or more different embodiments and/or ranges can be combined to form additional non-disclosed and/or new ranges, or even new embodiments.

In one embodiment, the Portland cement component (b) of the present invention is composed primarily of Portland cement with optionally from 0 weight percent to about 7 weight percent limestone, or from about 0.25 weight percent to about 6.75 weight percent limestone, or from about 0.5 weight percent to about 6.5 weight percent limestone, or from about 0.75 weight percent to about 6.25 weight percent limestone, or from about 1 weight percent to about 6 weight percent limestone, or from about 1.25 weight percent to about 5.75 weight percent limestone, or from about 1.5 weight percent to about 5.5 weight percent limestone, or from about 1.75 weight percent to about 5.25 weight percent limestone, or from about 2 weight percent to about 5 weight percent limestone, or from about 2.25 weight percent to about 4.75 weight percent limestone, or from about 2.5 weight percent to about 4.5 weight percent limestone, or from about 2.75 weight percent to about 4.25 weight percent limestone, or from about 3 weight percent to about 4 weight percent limestone, or from about 3.25 weight percent to about 3.75 weight percent limestone, or even about 3.5 weight percent limestone. Here, as well as elsewhere in the specification and claims, individual numerical range limit values from any one or more different embodiments and/or ranges can be combined to form additional non-disclosed and/or new ranges, or even new embodiments.

In one embodiment, the Portland cement component (b) of the present invention is composed primarily of Portland cement with optionally from 0 weight percent to about 6 weight percent magnesium oxide (MgO), or from about 0.25 weight percent to about 5.75 weight percent magnesium oxide (MgO), or from about 0.5 weight percent to about 5.5 weight percent magnesium oxide (MgO), or from about 0.75 weight percent to about 5.25 weight percent magnesium oxide (MgO), or from about 1 weight percent to about 5 weight percent magnesium oxide (MgO), or from about 1.25 weight percent to about 4.75 weight percent magnesium oxide (MgO), or from about 1.5 weight percent to about 4.5 weight percent magnesium oxide (MgO), or from about 1.75 weight percent to about 4.25 weight percent magnesium oxide (MgO), or from about 2 weight percent to about 4 weight percent magnesium oxide (MgO), or from about 2.25 weight percent to about 3.75 weight percent magnesium oxide (MgO), or from about 2.5 weight percent to about 3.5 weight percent magnesium oxide (MgO), or from about 2.75 weight percent to about 3.25 weight percent magnesium oxide (MgO), or even about 3 weight percent magnesium oxide (MgO). Here, as well as elsewhere in the specification and claims, individual numerical range limit values from any one or more different embodiments and/or ranges can be combined to form additional non-disclosed and/or new ranges, or even new embodiments.

### Component (c)

As noted above, component (c) of the present soil additive is calcite, calcium oxide, calcium hydroxide, calcium magnesium carbonate, calcium magnesium oxide, magnesium carbonate, or magnesium oxide, and optionally one or more silica crystalline quartzes and/or one or more silica-alumina crystalline quartzes. In one embodiment, component (c) of the present soil additive can be comprised of lime kiln dust. In another embodiment, component (c) is calcite where the calcite in question can be any grade from agricultural grade to lab grade to pharmaceutical grade to ACS reagent grade with one or more trace compounds, elements, anions, and/or cations therein. Ideally, in one embodiment, any calcite (CaCO₃) utilized in connection with the present invention should be at least 85 weight percent CaCO₃, at least 87.5 weight percent weight percent CaCO₃, at least 90 weight percent CaCO₃, at least 92.5 weight percent CaCO₃, at least 95 weight percent CaCO₃, at least 97.5 weight percent CaCO₃, at least 98 weight percent CaCO₃, at last 98.5 weight percent CaCO₃, at least 99 weight percent CaCO₃, or even at least 99.5 weight percent CaCO₃ with any one or more typical, known, and/or common impurities and/or trace compounds, elements, anions, and/or cations therein.

In still another embodiment, component (c) comprises 0 weight percent to about 90 weight percent calcite, from 0 weight percent to about 50 weight percent calcium oxide, from 0 weight percent to about 70 weight percent calcium hydroxide, from 0 weight percent to about 50 weight percent calcium magnesium carbonate, from 0 weight percent to about 50 weight percent calcium magnesium oxide, from 0 weight percent to about 5 weight percent magnesium carbonate, from 0 weight percent to about 5 weight percent magnesium oxide, and optionally from 0 weight percent to about 10 weight percent of one or more silica crystalline quartzes and/or one or more silica-alumina crystalline quartzes. Here, as well as elsewhere in this specification, it should be noted that although the total amount of each portion of component (c) may individually total less than 100 weight percent when each portion thereof is taken individually and totaled using less than the broadest amounts disclosed herein, one of skill in the art will realize that this is not the case. Rather, each individual portion of component (c) of the present invention can be varied within any stated range as desired in order to achieve a total weight percent of 100.

In one embodiment, the component (c) comprises about 0 weight percent to about 90 weight percent calcite, from about 2.5 weight percent to about 87.5 weight percent calcite, from about 5 weight percent to about 85 weight percent calcite, from about 7.5 weight percent to about 82.5 weight percent calcite, from about 10 weight percent to about 80 weight percent calcite, from about 12.5 weight percent to about 77.5 weight percent calcite, from about 15 weight percent to about 75 weight percent calcite, from about 17.5 weight percent to about 72.5 weight percent calcite, from about 20 weight percent to about 70 weight percent calcite, from about 22.5 weight percent to about 67.5 weight percent calcite, from about 25 weight percent to about 65 weight percent calcite, from about 27.5 weight percent to about 62.5 weight percent calcite, from about 30 weight percent to about 60 weight percent calcite, from about 32.5 weight percent to about 57.5 weight percent calcite, from about 35 weight percent to about 55 weight percent calcite, from about 37.5 weight percent to about 52.5 weight percent calcite, from about 40 weight percent to about 50 weight percent calcite, from about 42.5 weight percent to about 47.5 weight percent calcite, or even about 45 weight percent calcite. Here, as well as elsewhere in the specification and claims, individual numerical range limit values from any one or more different embodiments and/or ranges can be combined to form additional non-disclosed and/or new ranges, or even new embodiments.

In one embodiment, the component (c) of the present invention is composed of from about 0 weight percent to about 50 weight percent calcium oxide, from about 2.5 weight percent to about 47.5 weight percent calcium oxide, from about 5 weight percent to about 45 weight percent calcium oxide, from about 7.5 weight percent to about 42.5 weight percent calcium oxide, from about 10 weight percent to about 40 weight percent calcium oxide, from about 12.5 weight percent to about 37.5 weight percent calcium oxide, from about 15 weight percent to about 35 weight percent calcium oxide, from about 17.5 weight percent to about 32.5 weight percent calcium oxide, from about 20 weight percent to about 30 weight percent calcium oxide, from about 22.5 weight percent to about 27.5 weight percent calcium oxide, or even about 25 weight percent calcium oxide. Here, as well as elsewhere in the specification and claims, individual numerical range limit values from any one or more different embodiments and/or ranges can be combined to form additional non-disclosed and/or new ranges, or even new embodiments.

In one embodiment, the component (c) of the present invention is composed of from about 0 weight percent to about 70 weight percent calcium hydroxide, from about 2.5 weight percent to about 67.5 weight percent calcium hydroxide, from about 5 weight percent to about 65 weight percent calcium hydroxide, from about 7.5 weight percent to about 62.5 weight percent calcium hydroxide, from about 10 weight percent to about 60 weight percent calcium hydroxide, from about 12.5 weight percent to about 57.5 weight percent calcium hydroxide, from about 15 weight percent to about 55 weight percent calcium hydroxide, from about 17.5 weight percent to about 52.5 weight percent calcium hydroxide, from about 20 weight percent to about 50 weight percent calcium hydroxide, from about 22.5 weight percent to about 47.5 weight percent calcium hydroxide, from about 25 weight percent to about 45 weight percent calcium hydroxide, from about 27.5 weight percent to about 42.5 weight percent calcium hydroxide, from about 30 weight percent to about 40 weight percent calcium hydroxide, from about 32.5 weight percent to about 37.5 weight percent calcium hydroxide, or even about 35 weight percent calcium hydroxide. Here, as well as elsewhere in the specification and claims, individual numerical range limit values from any one or more different embodiments and/or ranges can be combined to form additional non-disclosed and/or new ranges, or even new embodiments.

In one embodiment, the component (c) of the present invention is composed of from about 0 weight percent to about 50 weight percent calcium magnesium carbonate, from about 2.5 weight percent to about 47.5 weight percent calcium magnesium carbonate, from about 5 weight percent to about 45 weight percent calcium magnesium carbonate, from about 7.5 weight percent to about 42.5 weight percent calcium magnesium carbonate, from about 10 weight percent to about 40 weight percent calcium magnesium carbonate, from about 12.5 weight percent to about 37.5 weight percent calcium magnesium carbonate, from about 15 weight percent to about 35 weight percent calcium magnesium carbonate, from about 17.5 weight percent to about 32.5 weight percent calcium magnesium carbonate, from about 20 weight percent to about 30 weight percent calcium magnesium carbonate, from about 22.5 weight percent to about 27.5 weight percent calcium magnesium carbonate, or even about 25 weight percent calcium magnesium carbonate. Here, as well as elsewhere in the specification and claims, individual numerical range limit values from any one or more different embodiments and/or ranges can be combined to form additional non-disclosed and/or new ranges, or even new embodiments.

In one embodiment, the component (c) of the present invention is composed of from about 0 weight percent to about 50 weight percent calcium magnesium oxide, from about 2.5 weight percent to about 47.5 weight percent calcium magnesium oxide, from about 5 weight percent to about 45 weight percent calcium magnesium oxide, from about 7.5 weight percent to about 42.5 weight percent calcium magnesium oxide, from about 10 weight percent to about 40 weight percent calcium magnesium oxide, from about 12.5 weight percent to about 37.5 weight percent calcium magnesium oxide, from about 15 weight percent to about 35 weight percent calcium magnesium oxide, from about 17.5 weight percent to about 32.5 weight percent calcium magnesium oxide, from about 20 weight percent to about 30 weight percent calcium magnesium oxide, from about 22.5 weight percent to about 27.5 weight percent calcium magnesium oxide, or even about 25 weight percent calcium magnesium oxide. Here, as well as elsewhere in the specification and claims, individual numerical range limit values from any one or more different embodiments and/or ranges can be combined to form additional non-disclosed and/or new ranges, or even new embodiments.

In one embodiment, the component (c) of the present invention is composed of from 0 weight percent to about 5 weight percent magnesium carbonate, or from about 0.25 weight percent to about 4.75 weight percent magnesium carbonate, or from about 0.5 weight percent to about 4.5 weight percent magnesium carbonate, or from about 0.75 weight percent to about 4.25 weight percent magnesium carbonate, or from about 1 weight percent to about 4 weight percent magnesium carbonate, or from about 1.25 weight percent to about 3.75 weight percent magnesium carbonate, or from about 1.5 weight percent to about 3.5 weight percent magnesium carbonate, or from about 1.75 weight percent to about 3.25 weight percent magnesium carbonate, or from about 2 weight percent to about 3 weight percent magnesium carbonate, or from about 2.25 weight percent to about 2.75 weight percent magnesium carbonate, or even about 2.5 weight percent magnesium carbonate. Here, as well as elsewhere in the specification and claims, individual numerical range limit values from any one or more different embodiments and/or ranges can be combined to form additional non-disclosed and/or new ranges, or even new embodiments.

In one embodiment, the component (c) of the present invention is composed of from 0 weight percent to about 5 weight percent magnesium oxide, or from about 0.25 weight percent to about 4.75 weight percent magnesium oxide, or from about 0.5 weight percent to about 4.5 weight percent magnesium oxide, or from about 0.75 weight percent to about 4.25 weight percent magnesium oxide, or from about 1 weight percent to about 4 weight percent magnesium oxide, or from about 1.25 weight percent to about 3.75 weight percent magnesium oxide, or from about 1.5 weight percent to about 3.5 weight percent magnesium oxide, or from about 1.75 weight percent to about 3.25 weight percent magnesium oxide, or from about 2 weight percent to about 3 weight percent magnesium oxide, or from about 2.25 weight percent to about 2.75 weight percent magnesium oxide, or even about 2.5 weight percent magnesium oxide. Here, as well as elsewhere in the specification and claims, individual numerical range limit values from any one or more different embodiments and/or ranges can be combined to form additional non-disclosed and/or new ranges, or even new embodiments.

In one embodiment, the component (c) of the present invention is composed of optionally from 0 weight percent to about 10 weight percent one or more silica crystalline quartzes and/or one or more silica-alumina crystalline quartzes, or from about 0.25 weight percent to about 9.75 weight percent one or more silica crystalline quartzes and/or one or more silica-alumina crystalline quartzes, or from about 0.5 weight percent to about 9.5 weight percent one or more silica crystalline quartzes and/or one or more silica-alumina crystalline quartzes, or from about 0.75 weight percent to about 9.25 weight percent one or more silica crystalline quartzes and/or one or more silica-alumina crystalline quartzes, or from about 1 weight percent to about 9 weight percent one or more silica crystalline quartzes and/or one or more silica-alumina crystalline quartzes, or from about 1.25 weight percent to about 8.75 weight percent one or more silica crystalline quartzes and/or one or more silica-alumina crystalline quartzes, or from about 1.5 weight percent to about 8.5 weight percent one or more silica crystalline quartzes and/or one or more silica-alumina crystalline quartzes, or from about 1.75 weight percent to about 8.25 weight percent one or more silica crystalline quartzes and/or one or more silica-alumina crystalline quartzes, or from about 2 weight percent to about 8 weight percent one or more silica crystalline quartzes and/or one or more silica-alumina crystalline quartzes, or from about 2.25 weight percent to about 7.75 weight percent one or more silica crystalline quartzes and/or one or more silica-alumina crystalline quartzes, or from about 2.5 weight percent to about 7.5 weight percent one or more silica crystalline quartzes and/or one or more silica-alumina crystalline quartzes, or from about 2.75 weight percent to about 7.25 weight percent one or more silica crystalline quartzes and/or one or more silica-alumina crystalline quartzes, or from about 3 weight percent to about 7 weight percent one or more silica crystalline quartzes and/or one or more silica-alumina crystalline quartzes, or from about 3.25 weight percent to about 6.75 weight percent one or more silica crystalline quartzes and/or one or more silica-alumina crystalline quartzes, or from about 3.5 weight percent to about 6.5 weight percent one or more silica crystalline quartzes and/or one or more silica-alumina crystalline quartzes, or from about 3.75 weight percent to about 6.25 weight percent one or more silica crystalline quartzes and/or one or more silica-alumina crystalline quartzes, or from about 4 weight percent to about 6 weight percent one or more silica crystalline quartzes and/or one or more silica-alumina crystalline quartzes, or from about 4.25 weight percent to about 5.75 weight percent one or more silica crystalline quartzes and/or one or more silica-alumina crystalline quartzes, or from about 4.5 weight percent to about 5.5 weight percent one or more silica crystalline quartzes and/or one or more silica-alumina crystalline quartzes, or from about 4.75 weight percent to about 5.25 weight percent one or more silica crystalline quartzes, or even about 5 weight percent one or more silica crystalline quartzes and/or one or more silica-alumina crystalline quartzes. Here, as well as elsewhere in the specification and claims, individual numerical range limit values from any one or more different embodiments and/or ranges can be combined to form additional non-disclosed and/or new ranges, or even new embodiments.

### Method of Treating Soil

Turning to a method of utilizing the soil additive of the present invention, one such method includes the following steps of: (Step 1) assess the soil type and/or site to be treated; (Step 2) analyze chemical make-up of existing soil including at least the water content of soil to be treated; (Step 3) create a mixture of soil and the present invention's soil additive; (Step 4) excavate site to a minimum soil depth of at least 6 inches, at least 7 inches, at least 8 inches, at least 9 inches, at least 10 inches, at least 11 inches, at least 12 inches, at least 15 inches, or even at least 18 inches; (Step 5) deposit a mixture of soil additive and evacuated soil onto the excavated area with a lawn spreader set at about 400 pounds per 1000 square feet, about 425 pounds per 1000 square feet, about 450 pounds per 1000 square feet, about 475 pounds per 1000 square feet, about 500 pounds per 1000 square feet, about 525 pounds per 1000 square feet, about 550 pounds per 1000 square feet, about 575 pounds per 1000 square feet, about 600 pounds per 1000 square feet, about 625 pounds per 1000 square feet, about 650 pounds per 1000 square feet, about 675 pounds per 1000 square feet, about 700 pounds per 1000 square feet, about 725 pounds per 1000 square feet, about 750 pounds per 1000 square feet, about 775 pounds per 1000 square feet, or even about 800 pounds per 1000 square feet; (Step 6) place remaining excavated soil in 6 inch lift; (Step 7) use cultivator and rototiller to mix soil for 10 minutes per 100 square feet; (Step 8) use vibratory roller to compaction for 10 minutes per 100 square feet; (Step 9) deposit a second mixture of soil additive and evacuated soil onto the excavated area with a lawn spreader set at about 5 pounds per 1000 square feet, about 4.5 pounds per 1000 square feet, or even about 4 pounds per 1000 square feet; (Step 10) place remaining excavated soil back onto excavated site; (Step 11) use a cultivator and rototiller to mix soil for 10 minutes per 100 square feet; (Step 12) use a vibratory roller to compact soil site for 10 minutes per 100 square feet; and (Step 13) mist site with water after compaction to control dust for 1 minute. Here, as well as elsewhere in the specification and claims, individual numerical range limit values from any one or more different embodiments and/or ranges can be combined to form additional non-disclosed and/or new ranges, or even new embodiments.

### Amounts of Components (a), (b), and (c) in Soil Additive

As to the amount of components (a), (b), and (c) utilized to form the soil additive of the present invention, if a soil to be treated has less than 10 percent water content by weight, then the soil additive of the present invention is formed from about 45 weight percent to about 55 weight percent hydrated lime component (a2), from about 35 weight percent to about 45 weight percent Portland cement component (b), and from about 5 weight percent to about 15 weight percent component (c). Here, as well as elsewhere in this specification, it should be noted that although the total amount of each portion of the soil additive of the present invention may individually total less than 100 weight percent when each portion thereof is taken individually and totaled using less than the broadest amounts disclosed herein, one of skill in the art will realize that this is not the case. Rather, each individual portion of components (a2), (b), and (c) of the soil additive of the present invention can be varied within any stated range as desired in order to achieve a total weight percent of 100.

In another embodiment, if a soil to be treated has less than 10 percent water content by weight, then the soil additive of the present invention is formed from about 45 weight percent to about 55 weight percent component (a2), from about 46 weight percent to about 54 weight percent component (a2), from about 47 weight percent to about 53 weight percent component (a2), from about 48 weight percent to about 52 weight percent component (a2), from about 49 weight percent to about 51 weight percent component (a2), or even about 50 weight percent component (a2). Here, as well as elsewhere in the specification and claims, individual numerical range limit values from any one or more different embodiments and/or ranges can be combined to form additional non-disclosed and/or new ranges, or even new embodiments.

In another embodiment, if a soil to be treated has less than 10 percent water content by weight, then the soil additive of the present invention is formed from about 35 weight percent to about 45 weight percent component (b), from about 36 weight percent to about 44 weight percent component (b), from about 37 weight percent to about 43 weight percent component (b), from about 38 weight percent to about 42 weight percent component (b), from about 39 weight percent to about 41 weight percent component (b), or even about 40 weight percent component (b). Here, as well as elsewhere in the specification and claims, individual numerical range limit values from any one or more different embodiments and/or ranges can be combined to form additional non-disclosed and/or new ranges, or even new embodiments.

In another embodiment, if a soil to be treated has less than 10 percent water content by weight, then the soil additive of the present invention is formed from about 5 weight percent to about 15 weight percent component (c), from about 6 weight percent to about 14 weight percent component (c), from about 7 weight percent to about 13 weight percent component (c), from about 8 weight percent to about 12 weight percent component (c), from about 9 weight percent to about 11 weight percent component (c), or even about 10 weight percent component (c). Here, as well as elsewhere in the specification and claims, individual numerical range limit values from any one or more different embodiments and/or ranges can be combined to form additional non-disclosed and/or new ranges, or even new embodiments.

As to the amount of components (a), (b), and (c) utilized to form the soil additive of the present invention, if a soil to be treated has between about 10 percent and about 20 percent water content by weight, then the soil additive of the present invention is formed from about 5 weight percent to about 15 weight percent quicklime component (a1), from about 35 weight percent to about 45 weight percent hydrated lime component (a2), from about 25 weight percent to about 35 weight percent Portland cement component (b), and from about 15 weight percent to about 25 weight percent component (c). Here, as well as elsewhere in this specification, it should be noted that although the total amount of each portion of the soil additive of the present invention may individually total less than 100 weight percent when each portion thereof is taken individually and totaled using less than the broadest amounts disclosed herein, one of skill in the art will realize that this is not the case. Rather, each individual portion of components (a1), (a2), (b), and (c) of the soil additive of the present invention can be varied within any stated range as desired in order to achieve a total weight percent of 100.

In another embodiment, if a soil to be treated has between about 10 percent and about 20 percent water content by weight, then the soil additive of the present invention is formed from about 5 weight percent to about 15 weight percent component (a1), from about 6 weight percent to about 14 weight percent component (a1), from about 7 weight percent to about 13 weight percent component (a1), from about 8 weight percent to about 12 weight percent component (a1), from about 9 weight percent to about 11 weight percent component (a1), or even about 10 weight percent component (a1). Here, as well as elsewhere in the specification and claims, individual numerical range limit values from any one or more different embodiments and/or ranges can be combined to form additional non-disclosed and/or new ranges, or even new embodiments.

In another embodiment, if a soil to be treated has between about 10 percent and about 20 percent water content by weight, then the soil additive of the present invention is formed from about 35 weight percent to about 45 weight percent component (a2), from about 36 weight percent to about 44 weight percent component (a2), from about 37 weight percent to about 43 weight percent component (a2), from about 38 weight percent to about 42 weight percent component (a2), from about 39 weight percent to about 41 weight percent component (a2), or even about 40 weight percent component (a2). Here, as well as elsewhere in the specification and claims, individual numerical range limit values from any one or more different embodiments and/or ranges can be combined to form additional non-disclosed and/or new ranges, or even new embodiments.

In another embodiment, if a soil to be treated has between about 10 percent and about 20 percent water content by weight, then the soil additive of the present invention is formed from about 25 weight percent to about 35 weight percent component (b), from about 26 weight percent to about 34 weight percent component (b), from about 27 weight percent to about 33 weight percent component (b), from about 28 weight percent to about 32 weight percent component (b), from about 29 weight percent to about 31 weight percent component (b), or even about 30 weight percent component (b). Here, as well as elsewhere in the specification and claims, individual numerical range limit values from any one or more different embodiments and/or ranges can be combined to form additional non-disclosed and/or new ranges, or even new embodiments.

In another embodiment, if a soil to be treated has between about 10 percent and about 20 percent water content by weight, then the soil additive of the present invention is formed from about 15 weight percent to about 25 weight percent component (c), from about 16 weight percent to about 24 weight percent component (c), from about 17 weight percent to about 23 weight percent component (c), from about 18 weight percent to about 22 weight percent component (c), from about 19 weight percent to about 21 weight percent component (c), or even about 20 weight percent component (c). Here, as well as elsewhere in the specification and claims, individual numerical range limit values from any one or more different embodiments and/or ranges can be combined to form additional non-disclosed and/or new ranges, or even new embodiments.

As to the amount of components (a), (b), and (c) utilized to form the soil additive of the present invention, if a soil to be treated has between about 20 percent and about 30 percent water content by weight, then the soil additive of the present invention is formed from about 25 weight percent to about 35 weight percent quicklime component (a1), from about 15 weight percent to about 25 weight percent hydrated lime component (a2), from about 15 weight percent to about 25 weight percent Portland cement component (b), and from about 25 weight percent to about 35 weight percent component (c). Here, as well as elsewhere in this specification, it should be noted that although the total amount of each portion of the soil additive of the present invention may individually total less than 100 weight percent when each portion thereof is taken individually and totaled using less than the broadest amounts disclosed herein, one of skill in the art will realize that this is not the case. Rather, each individual portion of components (a1), (a2), (b), and (c) of the soil additive of the present invention can be varied within any stated range as desired in order to achieve a total weight percent of 100.

In another embodiment, if a soil to be treated has between about 20 percent and about 30 percent water content by weight, then the soil additive of the present invention is formed from about 25 weight percent to about 35 weight percent component (a1), from about 26 weight percent to about 34 weight percent component (a1), from about 27 weight percent to about 33 weight percent component (a1), from about 28 weight percent to about 32 weight percent component (a1), from about 29 weight percent to about 31 weight percent component (a1), or even about 30 weight percent component (a1). Here, as well as elsewhere in the specification and claims, individual numerical range limit values from any one or more different embodiments and/or ranges can be combined to form additional non-disclosed and/or new ranges, or even new embodiments.

In another embodiment, if a soil to be treated has between about 20 percent and about 30 percent water content by weight, then the soil additive of the present invention is formed from about 15 weight percent to about 25 weight percent component (a2), from about 16 weight percent to about 24 weight percent component (a2), from about 17 weight percent to about 23 weight percent component (a2), from about 18 weight percent to about 22 weight percent component (a2), from about 19 weight percent to about 21 weight percent component (a2), or even about 20 weight percent component (a2). Here, as well as elsewhere in the specification and claims, individual numerical range limit values from any one or more different embodiments and/or ranges can be combined to form additional non-disclosed and/or new ranges, or even new embodiments.

In another embodiment, if a soil to be treated has between about 20 percent and about 30 percent water content by weight, then the soil additive of the present invention is formed from about 15 weight percent to about 25 weight percent component (b), from about 16 weight percent to about 24 weight percent component (b), from about 17 weight percent to about 23 weight percent component (b), from about 18 weight percent to about 22 weight percent component (b), from about 19 weight percent to about 21 weight percent component (b), or even about 20 weight percent component (b). Here, as well as elsewhere in the specification and claims, individual numerical range limit values from any one or more different embodiments and/or ranges can be combined to form additional non-disclosed and/or new ranges, or even new embodiments.

In another embodiment, if a soil to be treated has between about 20 percent and about 30 percent water content by weight, then the soil additive of the present invention is formed from about 25 weight percent to about 35 weight percent component (c), from about 26 weight percent to about 34 weight percent component (c), from about 27 weight percent to about 33 weight percent component (c), from about 28 weight percent to about 32 weight percent component (c), from about 29 weight percent to about 31 weight percent component (c), or even about 30 weight percent component (c). Here, as well as elsewhere in the specification and claims, individual numerical range limit values from any one or more different embodiments and/or ranges can be combined to form additional non-disclosed and/or new ranges, or even new embodiments.

As to the amount of components (a), (b), and (c) utilized to form the soil additive of the present invention, if a soil to be treated has between about 30 percent and about 40 percent water content by weight, then the soil additive of the present invention is formed from about 45 weight percent to about 55 weight percent quicklime component (a1), from about 15 weight percent to about 25 weight percent Portland cement component (b), and from about 25 weight percent to about 35 weight percent component (c). Here, as well as elsewhere in this specification, it should be noted that although the total amount of each portion of the soil additive of the present invention may individually total less than 100 weight percent when each portion thereof is taken individually and totaled using less than the broadest amounts disclosed herein, one of skill in the art will realize that this is not the case. Rather, each individual portion of components (a1), (b), and (c) of the soil additive of the present invention can be varied within any stated range as desired in order to achieve a total weight percent of 100.

In another embodiment, if a soil to be treated has between about 30 percent and about 40 percent water content by weight, then the soil additive of the present invention is formed from about 45 weight percent to about 55 weight percent component (a1), from about 46 weight percent to about 54 weight percent component (a1), from about 47 weight percent to about 53 weight percent component (a1), from about 48 weight percent to about 52 weight percent component (a1), from about 49 weight percent to about 51 weight percent component (a1), or even about 50 weight percent component (a1). Here, as well as elsewhere in the specification and claims, individual numerical range limit values from any one or more different embodiments and/or ranges can be combined to form additional non-disclosed and/or new ranges, or even new embodiments.

In another embodiment, if a soil to be treated has between about 30 percent and about 40 percent water content by weight, then the soil additive of the present invention is formed from about 15 weight percent to about 25 weight percent component (b), from about 16 weight percent to about 24 weight percent component (b), from about 17 weight percent to about 23 weight percent component (b), from about 18 weight percent to about 22 weight percent component (b), from about 19 weight percent to about 21 weight percent component (b), or even about 20 weight percent component (b). Here, as well as elsewhere in the specification and claims, individual numerical range limit values from any one or more different embodiments and/or ranges can be combined to form additional non-disclosed and/or new ranges, or even new embodiments.

In another embodiment, if a soil to be treated has between about 30 percent and about 40 percent water content by weight, then the soil additive of the present invention is formed from about 25 weight percent to about 35 weight percent component (c), from about 26 weight percent to about 34 weight percent component (c), from about 27 weight percent to about 33 weight percent component (c), from about 28 weight percent to about 32 weight percent component (c), from about 29 weight percent to about 31 weight percent component (c), or even about 30 weight percent component (c). Here, as well as elsewhere in the specification and claims, individual numerical range limit values from any one or more different embodiments and/or ranges can be combined to form additional non-disclosed and/or new ranges, or even new embodiments.

As such, it will be readily appreciated by those skilled in the art that modification may be made to the invention without departing from the concepts disclosed in the foregoing description. Accordingly, the particular embodiments described in detail herein are illustrative only and are not limited to the scope of the invention, which is to be given the full breadth of the appended claims and any and all equivalents thereof.

What is claimed is:

1. A soil additive comprising:
component (a) one or more lime-based compounds;
component (b) one or more Portland cements; and
component (c) one or more of calcite, calcium oxide, calcium hydroxide, calcium magnesium carbonate, calcium magnesium oxide, magnesium carbonate, or magnesium oxide, and optionally one or more silica crystalline quartzes and/or one or more silica-alumina crystalline quartzes.

2. The soil additive of claim 1, wherein the soil additive further comprises one or more silica crystalline quartzes in one or more of component (a) or (c).

3. The soil additive of claim 1, wherein component (b) is formed from Type I Portland cement, Type IA Portland cement, Type II Portland cement, Type IIA Portland cement, Type II(MH) Portland cement, Type II(MH)A Portland cement, Type III Portland cement, Type IIIA Portland cement, Type IV Portland cement, Type V Portland cement, or mixtures of any two or more thereof.

4. The soil additive of claim 1, wherein component (b) optionally further comprises one or more of the following minor constituents comprising:
0 weight percent to about 7 weight percent calcium oxide (CaO);
0 weight percent to about 0.5 weight percent quartz;
about 2 weight percent to about 11 weight percent gypsum;
0 weight percent to about 7 weight percent limestone; and/or
0 weight percent to about 6 weight percent magnesium oxide (MgO).

5. The soil additive of claim 1, wherein component (b) optionally further comprises one or more of the following minor constituents comprising:
0 weight percent to about 5 weight percent calcium oxide (CaO);
0 weight percent to about 0.25 weight percent quartz;
about 3 weight percent to about 10 weight percent gypsum;
0 weight percent to about 6 weight percent limestone; and/or
0 weight percent to about 5 weight percent magnesium oxide (MgO).

6. The soil additive of claim 1, wherein component (b) optionally further comprises one or more of the following minor constituents comprising:
0 weight percent to about 5 weight percent calcium oxide (CaO);
0 weight percent to about 0.1 weight percent quartz;
about 4 weight percent to about 9 weight percent gypsum;
0 weight percent to about 5 weight percent limestone; and/or
0 weight percent to about 4 weight percent magnesium oxide (MgO).

7. The soil additive of claim 1, wherein component (a) is selected from a quicklime component (a1), a hydrated lime component (a2), or mixtures thereof.

8. The soil additive of claim 7, wherein the soil additive is formed from:
about 45 weight percent to about 55 weight percent hydrated lime component (a2);
about 35 weight percent to about 45 weight percent Portland cement component (b); and
about 5 weight percent to about 15 weight percent component (c).

9. The soil additive of claim 7, wherein the soil additive is formed from:
about 5 weight percent to about 15 weight percent quicklime component (a1);
about 35 weight percent to about 45 weight percent hydrated lime component (a2);
about 25 weight percent to about 35 weight percent Portland cement component (b); and
about 15 weight percent to about 25 weight percent component (c).

10. The soil additive of claim 7, wherein the soil additive is formed from:
about 25 weight percent to about 35 weight percent quicklime component (a1);
about 15 weight percent to about 25 weight percent hydrated lime component (a2);
about 15 weight percent to about 25 weight percent Portland cement component (b); and
about 25 weight percent to about 35 weight percent component (c).

11. The soil additive of claim 7, wherein the soil additive is formed from:
about 45 weight percent to about 55 weight percent quicklime component (a1);
about 15 weight percent to about 25 weight percent Portland cement component (b); and
about 25 weight percent to about 35 weight percent component (c).

12. A method of treating a soil with a soil additive, the method comprising the step of:
mixing the soil with a soil additive to yield a treated soil, the soil additive comprising:
component (a) one or more lime-based compounds;
component (b) one or more Portland cements; and
component (c) one or more of calcite, calcium oxide, calcium hydroxide, calcium magnesium carbonate, calcium magnesium oxide, magnesium carbonate, or magnesium oxide, and optionally one or more silica crystalline quartzes and/or one or more silica-alumina crystalline quartzes.

13. The method of claim 12, wherein the soil additive further comprises one or more silica crystalline quartzes in one or more of component (a) or (c).

14. The method of claim 12, wherein component (b) is formed from Type I Portland cement, Type IA Portland cement, Type II Portland cement, Type IIA Portland cement, Type II(MH) Portland cement, Type II(MH)A Portland cement, Type III Portland cement, Type IIIA Portland cement, Type IV Portland cement, Type V Portland cement, or mixtures of any two or more thereof.

15. The method of claim 12, wherein component (b) optionally further comprises one or more of the following minor constituents comprising:
0 weight percent to about 7 weight percent calcium oxide (CaO);
0 weight percent to about 0.5 weight percent quartz;
about 2 weight percent to about 11 weight percent gypsum;
0 weight percent to about 7 weight percent limestone; and/or
0 weight percent to about 6 weight percent magnesium oxide (MgO).

16. The method of claim 12, wherein component (b) optionally further comprises one or more of the following minor constituents comprising:
0 weight percent to about 5 weight percent calcium oxide (CaO);
0 weight percent to about 0.25 weight percent quartz;
about 3 weight percent to about 10 weight percent gypsum;
0 weight percent to about 6 weight percent limestone; and/or
0 weight percent to about 5 weight percent magnesium oxide (MgO).

17. The method of claim 12, wherein component (b) optionally further comprises one or more of the following minor constituents comprising:
0 weight percent to about 5 weight percent calcium oxide (CaO);
0 weight percent to about 0.1 weight percent quartz;
about 4 weight percent to about 9 weight percent gypsum;
0 weight percent to about 5 weight percent limestone; and/or
0 weight percent to about 4 weight percent magnesium oxide (MgO).

18. The method of claim 12, wherein component (a) is selected from a quicklime component (a1), a hydrated lime component (a2), or mixtures thereof.

19. The method of claim 18, wherein the soil additive is formed from:
Composition (1) when the water content of the soil to be treated is less than about 10 weight percent, wherein Composition (1) comprises:
about 45 weight percent to about 55 weight percent hydrated lime component (a2);
about 35 weight percent to about 45 weight percent Portland cement component (b); and
about 5 weight percent to about 15 weight percent component (c), or
Composition (2) when the water content of the soil to be treated is between about 10 weight percent and about 20 weight percent, wherein Composition (2) comprises:
about 5 weight percent to about 15 weight percent quicklime component (a1);
about 35 weight percent to about 45 weight percent hydrated lime component (a2);
about 25 weight percent to about 35 weight percent Portland cement component (b); and
about 15 weight percent to about 25 weight percent component (c), or
Composition (3) when the water content of the soil to be treated is between about 20 weight percent and about 30 weight percent, wherein Composition (3) comprises:
about 25 weight percent to about 35 weight percent quicklime component (a1);
about 15 weight percent to about 25 weight percent hydrated lime component (a2);
about 15 weight percent to about 25 weight percent Portland cement component (b); and
about 25 weight percent to about 35 weight percent component (c), or
Composition (4) when the water content of the soil to be treated is between about 30 weight percent and about 40 weight percent, wherein Composition (4) comprises:
about 45 weight percent to about 55 weight percent quicklime component (a1);
about 15 weight percent to about 25 weight percent Portland cement component (b); and
about 25 weight percent to about 35 weight percent component (c).
